(19) United States
(12) Patent Application Publication
(10) Pub. No.: US 2025/0123114 A1
(43) Pub. Date: Apr. 17, 2025

(54) NAVIGATION APPARATUS

(71) Applicant: TOYOTA JIDOSHA KABUSHIKI KAISHA, Toyota-shi (JP)

(72) Inventors: Ryusaku YAMAMOTO, Itabashi-ku (JP); Kohei WATANABE, Adachi-ku (JP); Takehira OTA, Inazawa-shi (JP); Shinya HIROSAWA, Nisshin-shi (JP); Yuto KAIDA, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 18/900,886

(22) Filed: Sep. 30, 2024

(30) Foreign Application Priority Data
Oct. 16, 2023 (JP) 2023-178452

(51) Int. Cl. G01C 21/36

(52) U.S. Cl. CPC G01C 21/3676

(57) ABSTRACT

A navigation apparatus of the present disclosure is a navigation apparatus to be mounted in a vehicle and configured to provide guidance on a route that the vehicle is to travel, and includes a positional information acquisition interface, a memory, an output interface configured to output information to a user, and a controller. The positional information acquisition interface is configured to acquire a current position of the vehicle. The memory is configured to store map information. The controller is configured to extract a guidance location on the route based on the current position and the map information, estimate a predicted time taken until arrival at the guidance location, and cause the output interface to output the predicted time.

### CROSS-REFERENCE TO RELATED APPLICATION

This application claims priority to Japanese Patent Application No. 2023-178452, filed on Oct. 16, 2023, the entire contents of which are incorporated herein by reference.

### TECHNICAL FIELD

The present disclosure relates to a navigation apparatus.

### BACKGROUND

A vehicle guidance apparatus that provides information guidance to a destination or a location where a course is to be changed using sensory expressions such as “Still ahead” and “Almost there” instead of the remaining distance is disclosed. For example, see Patent Literature (PTL) 1.

### CITATION LIST

### Patent Literature

PTL 1: JP H08-035847 A

### SUMMARY

When sensory expressions are used to guide users, they are received in different ways by different people, and the expressions may not match the senses of the users. In addition, guidance based on the remaining distance may also be difficult to understand intuitively.

It would be helpful to make it easier to understand guidance provided by a navigation apparatus more intuitively.

A navigation apparatus according to an embodiment of the present disclosure that solves the above problem is a navigation apparatus to be mounted in a vehicle and configured to provide guidance on a route that the vehicle is to travel, the navigation apparatus including:
a positional information acquisition interface configured to acquire a current position of the vehicle;
a memory configured to store map information;
an output interface configured to output information to a user; and
a controller configured to:
   extract a guidance location on the route based on the current position and the map information;
   estimate a predicted time taken until arrival at the guidance location; and
   cause the output interface to output the predicted time.

According to the present disclosure, a navigation apparatus that, when providing guidance on a route, communicates a guidance location on the route in an intuitively understandable manner using the time taken until arrival at the guidance location can be provided. This can make it easier to understand guidance provided by the navigation apparatus more intuitively.

### BRIEF DESCRIPTION OF THE DRAWINGS

In the accompanying drawings:

FIG. 1 is a block diagram illustrating a schematic configuration of a navigation apparatus according to an embodiment of the present disclosure;

FIG. 2 is a functional block diagram illustrating a schematic configuration of a controller in FIG. 1;

FIG. 3 is a diagram illustrating an example of guidance of a guidance location provided by the navigation apparatus in FIG. 1; and

FIG. 4 is a flowchart illustrating an example of processing executed by the controller in FIG. 1.

### DETAILED DESCRIPTION

An embodiment of the present disclosure will be described below, with reference to the drawings. The drawings used in the following description are schematic. Dimensions, ratios, and the like on the drawings do not necessarily match actual ones.

### System Overview

The navigation apparatus 10 of one embodiment of the present disclosure is an apparatus that is to be mounted in a vehicle and displays a map to the user, a passenger in the vehicle, and provides guidance on a route to a destination. Vehicles include, but are not limited to, passenger cars, trucks, buses, and large and small special-purpose automobile. Vehicles include various types of vehicles that will be realized in the future. For example, vehicles may include automated vehicles, amphibious vehicles, and air/land vehicles.

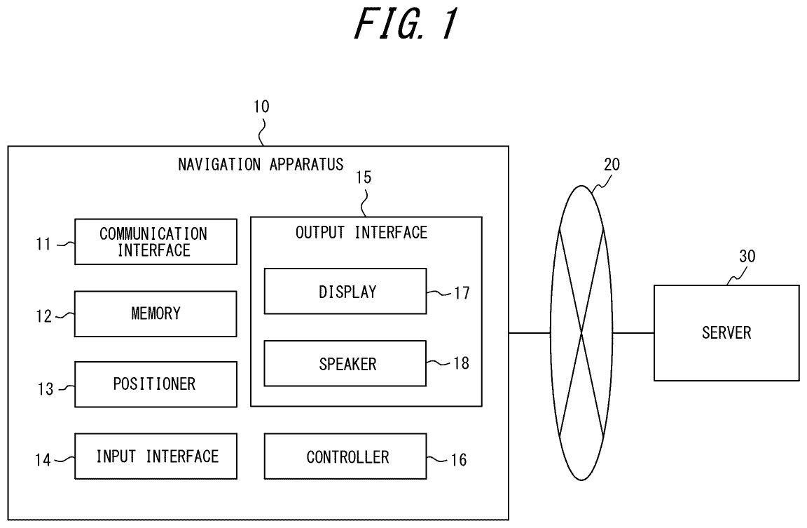

As illustrated in FIG. 1, the navigation apparatus 10 may be configured communicably with various servers 30 external to the vehicle via the communication network 20. The communication network 20 may include the Internet, a Virtual Private Network (VPN), a mobile communication network, and the like.

The servers 30 can provide traffic information to the navigation apparatus 10. The servers 30 include servers of government agencies with jurisdiction over traffic management, road administrators, and businesses that provide traffic information. The servers 30 can provide information on road congestion, traffic congestion, and accidents. The servers 30 may also include a server that provides road map information.

### Configuration of Navigation Apparatus

The navigation apparatus 10 includes a communication interface 11, a memory 12, a positioner 13, an input interface 14, an output interface 15, and a controller 16.

The communication interface 11 connects to the communication network 20 by wireless communication means and can acquire information from the servers 30. The wireless communication means include the 4th Generation (4G) mobile communication system, the 5th Generation (5G) mobile communication system, Wi-Fi® (Wi-Fi is a registered trademark in Japan, other countries, or both), Worldwide Interoperability for Microwave Access (WiMAX), and the like. The communication interface 11 may further be compliant with Dedicated Short Range Communications (DSRC) or the like. The communication interface 11 may be configured to receive traffic information provision services using broadcast waves such as FM multiplex broadcasts.

The memory 12 includes at least one semiconductor memory, at least one magnetic memory, at least one optical memory, or any combination thereof. The semiconductor memory is, for example, random access memory

(RAM) or read only memory (ROM). The RAM is, for example, static random access memory (SRAM) or dynamic random access memory (DRAM). The ROM includes, for example, electrically erasable programmable read only memory (EEPROM). Magnetic memory may include, for example, a hard disk. The optical memory may include, for example, compact discs (CDs), digital versatile discs (DVDs), and Blu-ray® (Blu-ray is a registered trademark in Japan, other countries, or both). The memory 12 functions as, for example, a main memory, an auxiliary memory, or a cache memory. The memory 12 stores programs executed by the controller 16, data used in the operation of the controller 16, and data obtained by the operation of the controller 16.

The memory 12 can store road map information. Road map information consists of road network information, background map information, and facility information. Road network information expresses the connection and shape of roads by means of points called nodes and lines called links. Positional information for nodes and links is identified by latitude and longitude. Background map information includes information on the geometry of land, buildings, rivers, and rail lines in the background of the road. Facility information is information about facilities included in road maps. The memory 12 may continuously store road map information. The memory 12 may temporarily store road map information loaded from the server 30 that provides road maps via the communication interface 11 as needed.

The positioner 13 detects the position of the vehicle in which the navigation apparatus 10 is mounted. The positioner 13 functions as a positional information acquisition interface. The position detected by the positioner 13 can be a position expressed in latitude and longitude, or the like. The positioner 13 may include a receiving apparatus compliant with Global Navigation Satellite System (GNSS), which uses satellites. The receiving apparatus compliant with GNSS includes a Global Positioning System (GPS) receiver. By using signals from a GPS receiver, information on the latitude and longitude at the current position of the vehicle can be acquired. Signals from the GPS receiver can be combined with various detection devices such as heading sensors, rudder angle sensors, and distance sensors. In this way, the accuracy of position detection can be improved and position estimation can be performed in locations where radio waves from satellites do not reach. Receivers compliant with other types of GNSS, instead of GPS receivers or in addition to GPS receivers may be employed. Other GNSS include, for example, GLONASS, Galileo, Compass, and satellite positioning systems using quasi-zenith satellites.

The input interface 14 accepts inputs to the navigation apparatus 10. The input interface 14 may include a touch panel formed as an integral part of a display 17, which is described below, and a microphone that accepts voice input. The touch panel is a device that detects an input in response to a touch by the user. The touch panel accepts an input in conjunction with the content shown on the display 17. Various types of touch panels, such as capacitive, resistive, and surface acoustic wave, are included. The microphone converts the incoming voice into an audio signal and outputs it. In order to convert the voice signal output by the microphone into text, the navigation apparatus 10 may be configured to perform voice recognition processing in the controller 16, etc. The input interface 14 may further include a connector to receive input from external input devices.

The output interface 15 outputs the information processed by the navigation apparatus 10 to the user. The output interface 15 includes the display 17 and a speaker 18. The display 17 and the speaker 18 may be shared with equipment for other uses in the vehicle. The output interface 15 may include connectors that output information to the display 17, the speaker 18, and other output devices.

The display 17 is a device that displays images based on image signals obtained as a result of processing by the controller 16. The display 17 can employ various types of displays, such as a Liquid Crystal Display (LCD), an organic Electro-Luminescent (EL) display, an inorganic EL display, and a Plasma Display Panel (PDP). The display 17 may also be a Head Up Display (HUD). The HUD may project the display image onto the front windshield or onto a combiner placed on the dashboard.

The speaker 18 converts the audio signals into physical vibrations to thereby generate sound in space. As the speaker 18, an audio speaker installed in the vehicle may be used. Speakers 18 can be located on vehicle doors, dashboards and pillars, etc. As the speaker 18, a known typical speaker can be used.

The controller 16 includes at least one processor, at least one programmable circuit, at least one dedicated circuit, or any combination thereof. The processor is a general purpose processor such as a central processing unit (CPU) or a graphics processing unit (GPU), or a dedicated processor that is dedicated to specific processing. The programmable circuit is, for example, a field-programmable gate array (FPGA). The dedicated circuit is, for example, an application specific integrated circuit (ASIC).

The controller 16 executes various arithmetic processes related to operations of the navigation apparatus 10 while controlling components of the navigation apparatus 10. The controller 16 operates the various parts of the navigation apparatus 10 and makes the navigation apparatus 10 function.

### Configuration of Controller

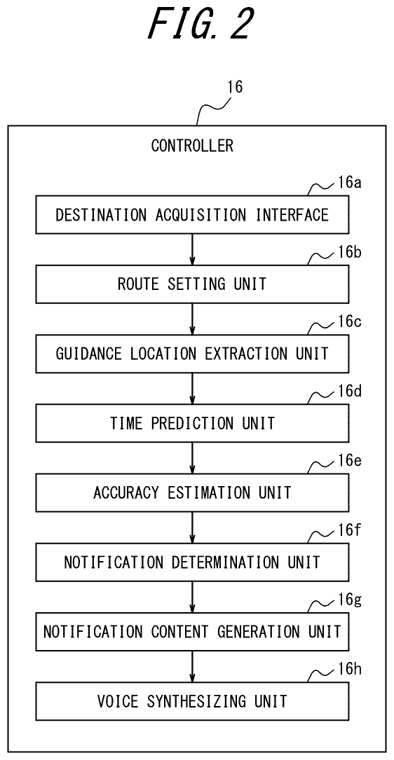

In one embodiment, the controller 16 includes a destination acquisition interface 16a, a route setting unit 16b, a guidance location extraction unit 16c, a time prediction unit 16d, an accuracy estimation unit 16e, a notification determination unit 16f, a notification content generation unit 16g, and a voice synthesizing unit 16h, as illustrated in FIG. 2. Each of these parts may be a hardware module or a software module. Each of these parts may be integrated with each other and/or divided into multiple parts. Processing executed by each component of the controller 16 can be referred to as processing executed by the controller 16.

The destination acquisition interface 16a acquires destination information from the user via the input interface 14. To allow users to easily input destinations, the destination acquisition interface 16a may provide a function to search for destinations from road map information stored in the memory 12. For example, the address and telephone number of a facility contained in the facility information of road map information may be used to search for a destination.

The route setting unit 16b can search for a route from the current position detected by the positioner 13 to the destination obtained by the destination acquisition interface 16a based on road map information stored in the memory 12. The route setting unit 16b may extract multiple routes and present them on the display 17. Users may be able to select one route from multiple routes. The route setting unit 16b sets the route selected by the user as the route to the destination. The route setting unit 16b can re-search and re-set a route when a user requests to re-search a route, or when a vehicle equipped with the navigation apparatus 10 deviates from the set route.

The guidance location extraction unit 16c extracts guidance locations that are subject to informing users of the predicted time taken until arrival. The guidance location is a point on the established route. Guidance locations include, for example, intersections where right or left turns are made on the route, or junctions where left and right branches are made. Guidance locations may also include locations with landmarks on the route and points with facilities related to road traffic. Landmarks may include famous buildings, bridges and train stations. Facilities associated with road traffic may include, for example, gas stations and drive-ins. In addition, the guidance location may include a destination.

The guidance location extraction unit 16c may extract the next guidance location on the route from the current position. The guidance location extraction unit 16c, for example, extracts the next guidance location when the previous guide point is passed. The guidance location extraction unit 16c may extract guide points after the next guidance location according to predetermined conditions or according to instructions from the user via the input interface 14.

The time prediction unit 16d predicts the time taken for a vehicle equipped with the navigation apparatus 10 to arrive at the guidance location. The time predicted by the time prediction unit 16d is called the predicted time. For example, the time prediction unit 16d calculates the distance from the current position to the guidance location based on road map information. The time prediction unit 16d may calculate the time it takes for the vehicle equipped with the navigation apparatus 10 to travel the distance to the guidance location at the predicted speed of the vehicle. The time prediction unit 16d can use the most recent average speed that the vehicle has actually traveled as the predicted speed. The average speed in the immediate past can be the average speed from a predetermined time before the current time to the current time. The time prediction unit 16d may also use the speed limit of the route the vehicle is to travel as the predicted speed. The speed at which the vehicle actually traveled may be calculated by the controller 16 based on changes in the current position detected by the positioner 13. Alternatively, the controller 16 may obtain measured speed information for the speedometer from the vehicle in which the navigation apparatus 10 is mounted.

When the time prediction unit 16d obtains traffic information indicating status of congestion of the route to be traveled from a server 30 via the communication interface 11, it may estimate the predicted time by considering such traffic information. For example, when traffic information includes information indicating the level of congestion on the route, the time prediction unit 16d estimates the average travel speed in the congested section and uses that average speed to calculate the predicted time. The time prediction unit 16d may determine that it is impossible to calculate the predicted time when there is severe traffic congestion on the route and when there is an accident.

When there is a traffic light on the route, the time prediction unit 16d may calculate the average waiting time based on the interval at which the traffic light switches and use it to calculate the predicted time. The time prediction unit 16d may use the standard signal switching time as the signal switching time. Alternatively, the time prediction unit 16d may be configured to store the individual signal switching times in the memory 12 or acquire them from a server 30. The time prediction unit 16d may also consider right turns, left turns, temporary stops, etc. on the route as factors that affect the predicted time.

The accuracy estimation unit 16e evaluates the accuracy of the predicted time taken until arrival at the guidance location. Various methods can be used to evaluate prediction accuracy. For example, the accuracy estimation unit 16e estimates the error rate of the predicted time as the prediction accuracy. The error rate can be the ratio of the estimated error in the predicted time to the predicted time. That is, the error rate is calculated by the following equation:

error rate=estimated error in predicted time/predicted time

For example, the accuracy estimation unit 16e extracts the factors that cause errors in the predicted time on the route and quantifies and sums the errors estimated by these factors. For example, congestion on the route is a factor that can add error to the predicted time. The accuracy estimation unit 16e calculates the error in the predicted time based on congestion. The error in the predicted time according to congestion may be determined based on information stored in the memory 12 or an external server 30 in the past. In addition, if there is a traffic light, the timing of the traffic light changeover can cause a forecast error. For example, the accuracy estimation unit 16e may add the difference between the average signal waiting time and the maximum signal waiting time to the estimate of the predicted time error. Furthermore, when making right turns, left turns, and pauses along the route, there are individual differences in deceleration and acceleration at these locations, which can cause errors in the predicted time. Therefore, the accuracy estimation unit 16e adds up the estimates of the predicted time error according to the number of these locations.

The notification determination unit 16f determines whether or not to notify the user of the predicted time. In one embodiment, the notification determination unit 16f may determine that the notification of the predicted time will not be provided when the predicted time is shorter than the predetermined time. The predetermined time is, for example, 10 seconds, 20seconds, or 30 seconds, but these examples are not limiting. Instead of the predicted time, the notification determination unit 16f may determine that no notification will be made based on the distance to the guidance location. If the distance to the guidance location is short, the time to reach the guidance location may vary greatly due to vehicle deceleration in front of the guidance location. As a result, the predicted time and the time when the vehicle actually arrives at the guidance location may deviate. Therefore, informing users of the predicted time just before the guidance location may instead cause misunderstanding or confusion. By not providing notification of the predicted time, the controller 16 can avoid the misunderstanding or confusion described above.

In one embodiment, if the time prediction unit 16d determines in the process of calculating the predicted time that it is impossible to calculate the predicted time, the notification determination unit 16f may also determine that the notification of the predicted time will not be provided. For this reason, the notification of the predicted time is not provided when there is heavy traffic congestion on the route or when an accident is occurring. In this way, it is possible to avoid informing users of unreliable predicted times when the accuracy of the predicted arrival time to the guidance location is considered to be extremely low.

The notification determination unit 16f may determine that the notification of the predicted time is provided when the error rate estimated by the accuracy estimation unit 16e is equal to or less than a predetermined threshold and that the notification of the predicted time is not provided when the error rate exceeds the predetermined threshold. The predetermined threshold can be set to 0.1, 0.2 or 0.3, for example. That is, the accuracy estimation unit 16e determines that if the accuracy of the predicted time estimation is high, the notification of the predicted time will be provided, and if the accuracy of the predicted time estimation is low, the notification of the predicted time will not be provided. This allows the navigation apparatus 10 to notify users only of predicted times with a high degree of confidence.

The notification content generation unit 16g generates content of which the user is to be notified using the predicted time predicted by the time prediction unit 16d. The notification content includes “T₁ minutes ahead on the road”, “P₁ ahead. Approximately T₂ minutes to P₁”, “Right-turning location in T₃ seconds”, and so on. However, T₁ to T₃ shall represent time and P₁ shall represent the name of the location. The notification content generation unit 16g may generate a notification content to provide notification of the distance to the guidance location when the notification determination unit 16f determines that the notification of the predicted time is not to be provided.

The voice synthesizing unit 16h performs speech synthesis processing to generate a human voice from the text of the notification content generated by the notification content generation unit 16g in order to provide a voice signal to the speaker 18. As for speech synthesis, known technologies such as waveform-connected speech synthesis and statistical modeling synthesis can be employed. The voice synthesizing unit 16h outputs voice signals to the speaker 18, allowing the user to know the predicted time taken until arrival at the guidance location through the voice output from the speaker 18.

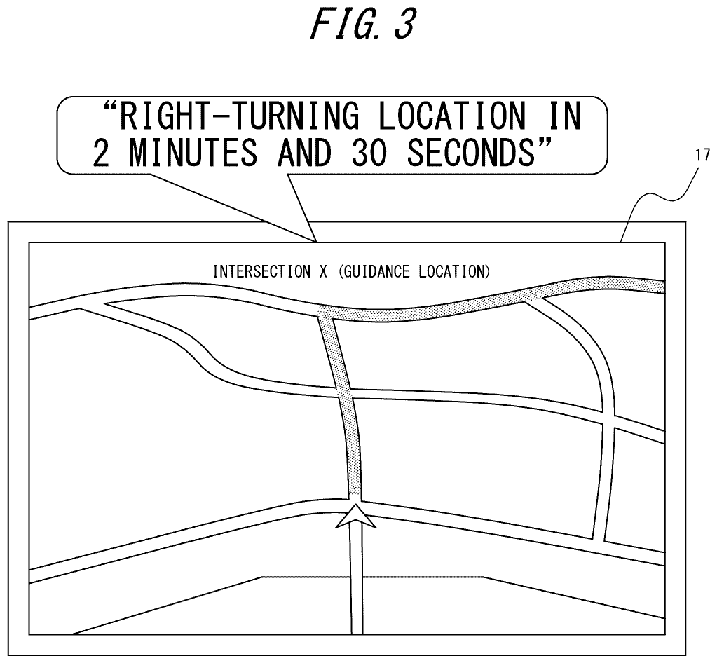

FIG. 3 illustrates an example of notification by the navigation apparatus 10. As shown on the display 17, the route that the vehicle equipped with the navigation apparatus 10 is planned to travel is to go straight and then turn right at intersection X. Intersection X is set as the next guidance location. The controller 16 predicts the time it will take to reach the intersection X and provides notification by voice and/or by text on the display 17 that the right-turning location will be reached after the predicted time has elapsed. As an example, the notification content by audio is described in the callout of FIG. 3. This allows the user to know in advance with plenty of time to make a right turn after the predicted time has elapsed. For example, a user can move the car to the right-leaning lane if there are multiple travel lanes. Thus, users will be able to make a smooth right turn at intersection X.

The timing for informing the user of the predicted time to the guidance location may be set under various conditions. For example, the controller 16 may be set to notify the user of the predicted time to the guidance location when the user has passed the previous guidance location and/or when the distance to the next guidance location is a predetermined length. The controller 16 may be set to provide notification of the predicted time to the next guidance location or destination at predetermined time intervals.

### Processes Executed by Controller

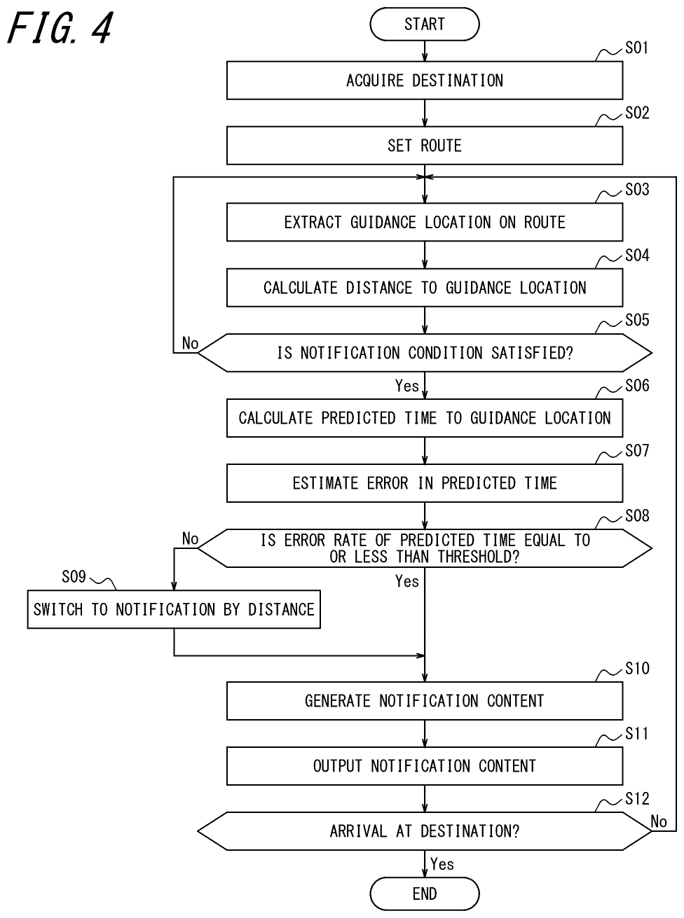

An example of a processing flow executed by the controller 16 of the navigation apparatus 10 will be described below using FIG. 4. FIG. 4 illustrates an example of the information processing method performed by the controller 16. The methods disclosed herein can be performed according to a program by a processor included in the controller 16. Such a program may be stored in a non-transitory computer readable medium. Examples of non-transitory computer readable media may include, but are not limited to, a hard disk, RAM, ROM, flash memory, a CD-ROM, an optical storage device, and a magnetic storage device.

The user shall be able to select whether or not to provide notification by the predicted time from the input interface 14 of the navigation apparatus 10. The user may make such a selection or change of selection before or during route guidance. The following process assumes that the user has selected guidance by predicted time.

First, the controller 16 acquires the destination entered by the user from the input interface 14 (S01).

The controller 16 searches for a route from the current position detected by the positioner 13 to the destination and sets the route (S02).

The controller 16 extracts guidance locations from the route (S03). The guidance locations to be extracted include the next guidance location to be reached by the vehicle.

The controller 16 calculates the distance from the vehicle with the navigation apparatus 10 to the guidance location (S04).

The controller 16 determines whether the notification condition to notify the user of the predicted time to the guidance location is satisfied (S05). For example, when the controller 16 passes one of the guidance locations, it may provide notification of the predicted time until the next guidance location. The controller 16 may also provide notification of the predicted time to the next or final guidance location, the destination, after each predetermined time elapses. Furthermore, the controller 16 may provide notification of the predicted time to the next guidance location when the distance to the next guidance location is within a predetermined distance. If the distance to the guidance location is not used to determine the notification conditions, S04 may be executed after S05.

When the notification condition is satisfied in S05 (S05: Yes), the controller 16 proceeds to S06. When the notification conditions are not satisfied in S05 (S05: No), the controller 16 returns to the process in S03.

When the notification condition is satisfied in S05 (S05: Yes), the controller 16 calculates the predicted time to the guidance location (S06).

The controller 16 estimates the error in the calculated predicted time (S07). The status of congestion of traffic on the route the vehicle is to travel, traffic lights, pauses, and right and left turns on the route, etc., can be taken into account as sources of predicted time errors. The controller 16 can estimate the maximum time it is expected to take from the current position until arrival at the guidance location, and the difference from the predicted time is the error. The maximum time may be calculated by adding the longest time it takes to pass through a congested section and the longest time to wait for a signal, etc.

The controller 16 determines whether the error rate of the predicted time is equal to or less than the threshold (S08). If the error rate is equal to or less than the threshold (S08: Yes), the controller 16 proceeds to S10. If the error rate exceeds the threshold (S08: No), the controller 16 proceeds to S09.

If the error rate exceeds a predetermined value (S08: No), the controller 16 may switch from notification by predicted time to notification by distance to the guidance location (S09). In the following description, it is assumed that the switch to notification by distance (S09) is not made.

The controller 16 may have other judgment conditions instead of or in addition to the judgment condition by error rate in S08. For example, the controller 16 may determine, based on the traffic information received from the server 30, that the notification of the predicted time will not be provided when there is severe congestion on the route to the guidance location or when an accident is occurring. When the distance to the next guidance location is short, the controller 16 may determine that the notification of the predicted time to the next guidance location is not to be provided.

Next, the controller 16 generates the notification content to notify the user (S10). The notification content includes the predicted time to the guidance location. The notification content may include information about the guidance location. For example, the notification content may include the name of the guidance location. If the guidance location is a right-turning location or a left-turning location, this information may be included. If there is no right or left turn to the guidance location, the notification content may include information indicating that the driver should go straight along the road to the guidance location.

The controller 16 causes the output interface 15 to output the notification content (S11). The controller 16 displays the notification content as text on the display 17 and/or converts it into an audio signal and causes it to be output as voice from the speaker 18 (S11). By being notified of the time it takes to reach the guidance location, the user can sense the approach of the guidance location. If the user is notified of the distance to the guidance location, even if the distance is the same, the time to reach the guidance location will vary depending on the speed. By informing the user of the time it will take to reach the guidance location, the user can sense how much time he/she has to reach the guidance location.

Unless the destination is not reached (S12: No), the controller 16 returns to S03 to continue route guidance including notification of the predicted time to the guidance location. When the controller 16 arrives at the destination (S12: Yes), the process ends.

As explained above, the present embodiment allows the user to easily grasp and communicate the guidance location on the route using the time taken until arrival at the guidance location when route guidance is provided. This makes the guidance of the navigation apparatus 10 more sensible and easier to understand.

It should be noted that the present disclosure is not limited to the above embodiment, and various modifications and revisions can be implemented. For example, functions or the like included in each means, each step, or the like can be rearranged without logical inconsistency, and a plurality of means, steps, or the like can be combined into one or divided.

In the above embodiment, the method used to determine the accuracy of the predicted time was the error rate of the predicted time based on the estimation of the error of the predicted time. However, the method of determining the accuracy of the predicted time is not limited to this.

For example, it is generally assumed that errors in predicted time are more likely to occur in urban areas due to traffic congestion, etc., while errors in predicted time are less likely to occur in suburban areas with low traffic volume. Therefore, the road map may be divided into urban and suburban areas, etc., and the accuracy of the predicted time may be determined by the percentage of urban areas included in the route traveled by the vehicle.

Machine learning may also be used to determine the accuracy of the predicted time. In other words, a large amount of data that has information on vehicle routes as input and errors between predicted and actual times as output is used as training data, and a pre-trained model is generated by a machine-learning computer. Using this learned model, the controller 16 may estimate the error in the predicted time for the route that is planned to be traveled.

In the above embodiment, the processing of the navigation apparatus 10 was performed by the controller 16 in the navigation apparatus 10. However, at least some of the processing of the controller 16 may be performed by a computer external to the navigation apparatus 10 via the communication network 20. For example, the navigation apparatus 10 may have an external computer perform the calculation of the predicted time to reach the guidance location and the estimation of the error in the predicted time.

1. A navigation apparatus to be mounted in a vehicle and configured to provide guidance on a route that the vehicle is to travel, the navigation apparatus comprising:
a positional information acquisition interface configured to acquire a current position of the vehicle;
a memory configured to store map information;
an output interface configured to output information to a user; and
a controller configured to:
extract a guidance location on the route based on the current position and the map information;
estimate a predicted time taken until arrival at the guidance location; and
cause the output interface to output the predicted time.

2. The navigation apparatus according to claim 1, wherein the controller is configured not to output the predicted time when a distance from the current position to the guidance location is shorter than a predetermined distance.

3. The navigation apparatus according to claim 1, wherein the controller is configured to:
evaluate accuracy of the predicted time; and
determine whether to output the predicted time based on the accuracy.

4. The navigation apparatus according to claim 3, wherein the controller is configured to:
estimate an error rate of the predicted time as the accuracy; and
output the predicted time when the error rate is equal to or less than a predetermined threshold.

5. The navigation apparatus according to claim 1, further comprising a communication interface capable of acquiring traffic information,
wherein the controller is configured to, when traffic information indicating a status of congestion of the route is acquired, estimate the predicted time according to the acquired traffic information.
